(19) United States
(12) Patent Application Publication
(10) Pub. No.: US 2010/0171493 A1
(43) Pub. Date: Jul. 8, 2010

(54) METHOD AND DEVICE FOR MEASURING THICKNESS OF A SUBSTRATE

(76) Inventor: Robert Standen, Calgary (CA)

Correspondence Address: Zarian Midgley & Johnson PLLC, University Plaza, 960 Broadway Ave., Suite 250, Boise, ID, 83706, US

(21) Appl. No.: 12/350,110

(22) Filed: Jan. 7, 2009

(51) Int. Cl. G01B 7/06

(52) U.S. Cl. 324/230

(57) ABSTRACT

A gauge for measuring the thickness of a piece of steel or other ferromagnetic substrate. The gauge may be used to measure the wall thickness of tubing, a pipe, a shim, a plate, etc, given that it's made from a material that a magnet might be attracted to. The gauge uses a force sensor to measure the force between a magnet and the tubing, pipe, shim, plate, etc. Because different thicknesses correspond to a different magnitude of force, the gauge may be used to find flaws and variations in the material. The gauge may use a force sensor that is approved for use in or near flammable environments.

### BACKGROUND

1. Field of the Invention

The present application relates generally to the inspection and measurement of substrates made of steel or other ferromagnetic material. Substrates may be used in load bearing applications where a departure from a specified material thickness may be undesirable. Such departures might occur over a small area, as may be caused by a corrosion pit, or over a large area, as may be caused by manufacturing variation or error.

2. Description of the Related Art

Commonly in industry, where it may be difficult to access both sides of a substrate, the thickness of the substrate may be measured by an inspection instrument located proximal to the substrate. For example, it may be difficult to measure the thickness of a substrate (e.g. pipe, tubing, coiled tubing, strip, plate, etc.) that has an extended length. The inspection instrument may be moved substantially continuously along the substrate, or vice versa. Inspection instruments may operate on ultrasonic or magnetic principles, and may require electricity, which may make the inspection instruments unsuitable for use in some environments.

For example, inspection instruments may be desired for use in an environment where flammable gases may be encountered, such as on or around oil refineries, oil wells and/or gas wells. Thus, it may be desirable for electrical equipment to be constructed such that an electrical fault is incapable of igniting flammable gases. Equipment designed toward overcoming inadvertent gas ignition is generally required to be certified by an approving authority, such as Underwriters Laboratories, OSHA, FM Global, Nationally Recognised Testing Laboratories, ETL, NSF International, the Canadian Standards Association, The TÜV Rheinland Group, and those approving authorities cooperating with the ATEX directive.

Some types of electrical sensing instruments (e.g. pressure sensors, temperature sensors, force sensors, etc.) are available for purchase, with certification from the approving authority, for use in flammable atmospheres. However, instruments that inspect the thickness of a ferromagnetic substrate are not readily available with certification, creating difficulties when it is desired to conduct an inspection in an environment having a potentially explosive atmosphere.

It would be beneficial to provide a method and/or apparatus for adapting available, certified sensors to effect an inspection of a ferromagnetic substrate, while maintaining safety from accidental ignition in a flammable atmosphere.

The present invention is directed toward overcoming, or at least reducing the effects of one or more of the issues set forth above.

### SUMMARY

One embodiment of the invention is a gauge for measuring the thickness of a ferromagnetic substrate, the gauge comprising at least one first magnet with a first polarity, the first magnet having a first polarity, a force measurement means operatively connected to the at least one first magnet, wherein the force measurement means is configured to measure the force between the at least one first magnet and a substrate, the substrate comprising ferromagnetic material, and wherein the at least one magnet is configured to magnetically saturate the substrate.

The gauge may further comprise at least one second magnet, having a second polarity. The at least one second magnet is oriented such that the second polarity is opposite the first polarity. The gauge may further comprise a yoke, comprising ferromagnetic material, connected to the at least one first magnet and the at least one second magnet, wherein the at least one first magnet is in substantially a same plane as the at least one second magnet, and wherein the force measurement means is operatively connected to the at least one first magnet and the at least one second magnet.

The gauge may further comprise a standoff means connected to the force measurement means which is configured to hold the at least one first magnet at a standoff distance from the substrate. The gauge may further comprise a distance measurement means, wherein the distance measurement means is configured to measure the distance between the at least one first magnet and the substrate. The substrate may comprise a pipe, a tube, coiled tubing, a strip, a shim, or a plate. The first magnet and the second magnet may be contoured to substantially match a contour of the substrate. The standoff distance may be configured to be about equal to or greater than the greatest expected thickness of the substrate. The force measurement means may comprise a mechanical scale, an accelerometer, a transducer, a load cell, a fiber optic strain sensor, hydrostatic load cell, spring balance gauge, or other suitable means. The force measurement means may be configured to prevent accidental ignition of flammable matter. The force measurement means may be certified by an approving authority for use in environments comprising flammable matter. The standoff means may comprise an arch and a movement means. The movement means may comprise a sliding member or a rotatable roller. The gauge may further comprise a frame, the frame may comprise a first frame member and a second frame member, the first frame member and the second frame member may be pivotally connected together, and a portion of the frame may be connected to the standoff means.

Another embodiment of the invention is an apparatus for inspecting the thickness of a substrate. The apparatus may comprise a frame, having a first frame member and a second frame member. The first frame member and the second frame member may be pivotally connected together. The apparatus includes at least one thickness measurement gauge. The at least one thickness measurement gauge may include a first magnet with a first polarity, a second magnet having a second polarity, the second magnet being oriented such that the second polarity is opposite the first polarity, and a yoke connecting the at least one first magnet and the at least one second magnet. The apparatus includes a force measurement means that may be connected to the yoke, and a standoff means operatively connected to the force measurement means. An aperture is formed in the middle of the frame and may be configured to accommodate a substrate that comprises ferromagnetic material. The force measurement means of the at least one thickness measurement gauge is configured to measure the force between the substrate and the at least one first magnet and the at least one second magnet.

The force measurement means may be configured to connect to a computer. The apparatus may include a speed sensor that may be configured to measure the speed of the substrate relative to the apparatus. The apparatus may include a temperature sensor, that may be configured to measure a temperature substantially proximate to the apparatus. The apparatus may include a tilt angle sensor that may be configured to measure a tilt of the apparatus with respect to the Earth.

An embodiment of the invention is a method for measuring the thickness of a substrate comprising holding at least one magnet at a standoff distance from a substrate, the substrate comprising ferromagnetic material, moving the substrate with respect to the magnet, measuring the force between the substrate and the magnet using a force measurement means, outputting the measured force between the substrate and the magnet from the force measurement means, and comparing the measured force at a first point along the substrate to the measured force at a second point along the substrate to find variation in the substrate.

The method may include using the measurement of the force between the substrate and the magnet to calculate a thickness of the substrate. The method may include calculating a difference in thickness between the first point and the second point. The substrate may comprise a pipe, tube, coiled tubing, strip, or plate. The force measurement means may be may comprise a mechanical scale, an accelerometer, a transducer, a load cell, a fiber optic strain sensor, hydrostatic load cell, spring balance gauge, or other suitable means. The force measurement means may be certified by an approving authority to be used in a flammable environment. The method may include displaying an output based at least partially on the outputted measured force.

These and other embodiments of the present application will be discussed more fully in the description. The features, functions, and advantages can be achieved independently in various embodiments of the claimed invention, or may be combined in yet other embodiments.

### BRIEF DESCRIPTION OF FIGURES

FIG. 1 is a cutaway side view of an embodiment of a thickness measurement gauge;

FIG. 2 is a cutaway side view of the thickness measurement gauge of FIG. 1 with magnetic flux density lines added;

FIG. 3 is a cutaway side view of the thickness measurement gauge of FIG. 1 with magnetic flux density lines;

FIG. 4 is a cutaway perspective view of another embodiment of a thickness measurement gauge;

FIG. 5 is a perspective view of yet another embodiment of a thickness measurement gauge;

FIG. 6 is a graph of a magnetization curve of a mild steel;

FIG. 7 is a side view of a coiled tubing reel;

FIG. 8 is a block diagram of an embodiment of a thickness measurement gauge.

Like reference numbers and designations in the various drawings indicate like elements.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

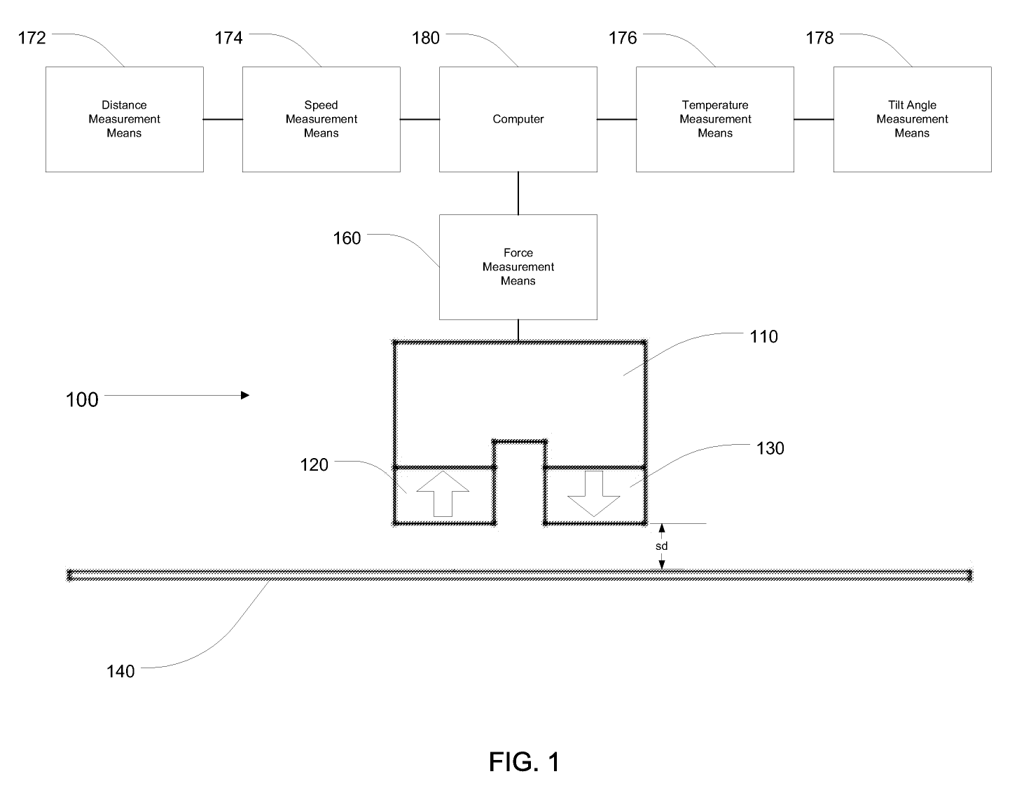

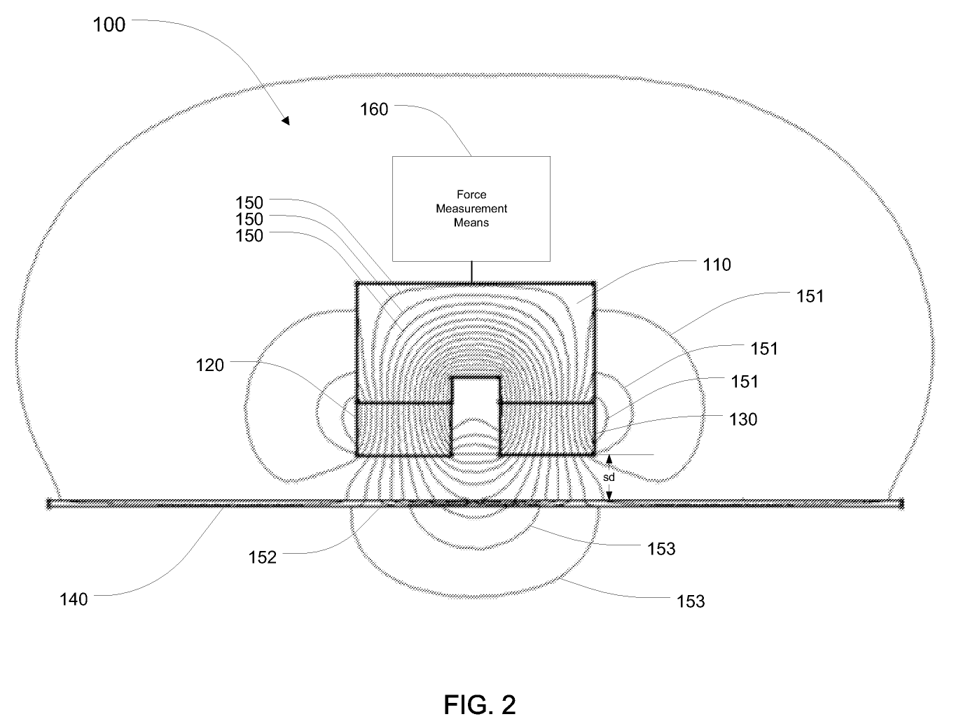

FIG. 1 is a cutaway side view of an embodiment of a thickness measurement gauge 100 that may measure the thickness of ferromagnetic material. The gauge 100 comprises a first magnet 120, polarized in a first direction, and a second magnet 130 polarized in a second direction that is opposite the first direction. The first magnet 120 and the second magnet 130 are connected by a connecting member (“yoke”) 110, which is comprised of a ferromagnetic material. Ferromagnetic material may include Iron (e.g. iron, steel, stainless steel, steel alloys), Nickel, Manganese, Chromium, or Cobalt, as well as alloys and rare earth metals, and ceramic materials, such as ferrites. The first magnet 120 and the second magnet 130 are connected to one side of the yoke 110, which may hold the magnets 120, 130 substantially within the same plane. The magnets 120, 130 generate a magnetic field that propagates through the yoke 110 (as shown in FIG. 2). Other configurations of the magnets 120, 130 and the yoke 110, such as swapping and/or reversing the magnets, would be apparent to one of ordinary skill in the art given the benefit of this disclosure.

Referring again to FIG. 1, a target substrate 140 is held at a standoff distance, sd, relative to the magnets 120,130 of the gauge 100. The target substrate 140 comprises ferromagnetic material, which may be attracted to the magnets 120, 130. When a magnet, such as the magnets 120, 130 of the gauge 100, is near ferromagnetic material, such as the target substrate 140, a force is seen between the two components and can be measured by a force measurement means 160. The magnitude of the force is affected by a number of variables. For example, the magnitude of the force is affected by the distance between the magnets 120, 130 to the target substrate 140; a greater distance corresponds to a smaller force. Also, the physical size of the magnets 120, 130, as well as the strength and direction (orientation) of the magnetic field generated by the magnets 120, 130, may affect the force. The shape of the magnets 120, 130 or the shape of the target substrate 140 may affect the force as well. For example, if the magnets 120, 130 are substantially planar and the target substrate 140 is not, then the magnetic field would be conducted more strongly by portions of the target substrate 140 that are closer to the magnets 120, 130, which may result in a different force than would be seen with complementarily shaped components.

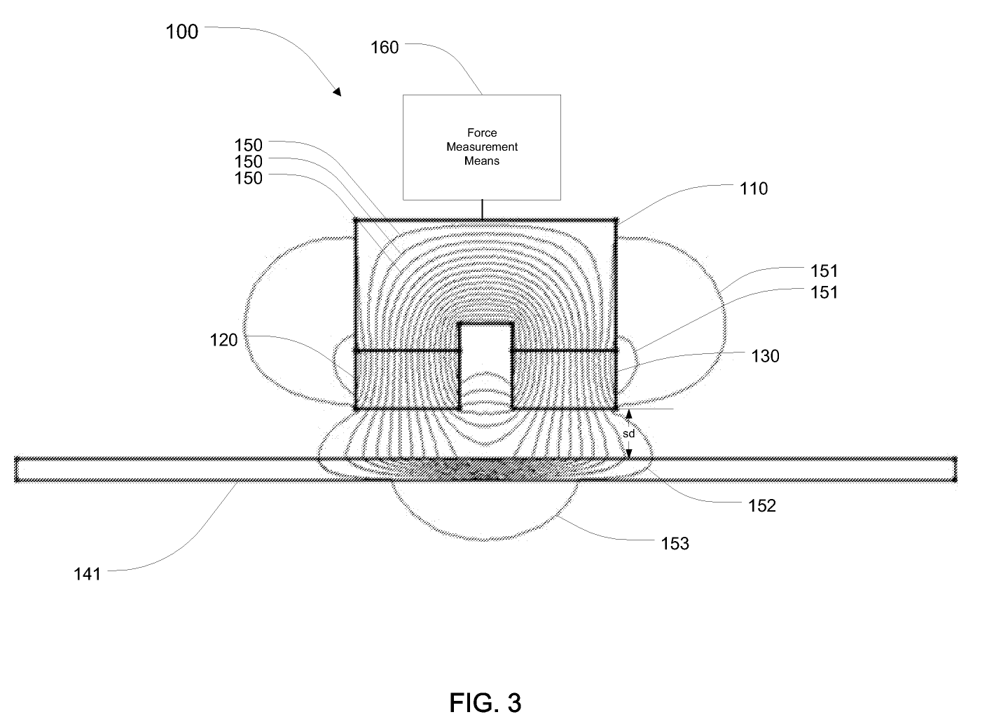

The material of the target substrate 140 may also affect the magnitude of the force between the substrate 140 and the magnets 120, 130. Generally, materials that have a greater permeability have a greater attraction to a magnet, resulting in a greater force seen between the magnet and the material. It may be said that a material with greater permeability may accommodate a greater magnetic flux density or may have a greater ability to conduct magnetic flux through itself than materials with lesser permeability. Additionally, a greater amount of a material may conduct more magnetic flux which will result in a greater force between the material and the source of the magnetic flux. For example, the target substrate 140 will generally produce a weaker force than a relatively thicker target substrate 141 (shown in FIG. 3) when near a magnet. The correspondence between force and thickness may be advantageously used for calculating the thickness of ferromagnetic material, such as the target substrate 140 without directly measuring the thickness. For example, if all other variables are held at substantially the same value, a change in the force between the target substrate 140 and the magnets 120, 130 will be attributable to a change in thickness of the target substrate 140. Because the thickness of the target substrate 140 and the force are related, if the force is known, the thickness may be predicted to an industrially useful degree of accuracy, such as within a hundredth of a inch, given that all other variables are held substantially constant, and that the target substrate 140 is in saturation, as will be further discussed later.

FIG. 2 is another side view of the gauge 100 of FIG. 1, comprising the first magnet 120, the second magnet 130, and the yoke 110, as well as the target substrate 140. FIG. 2 also illustrates magnetic flux lines. Magnetic flux lines can be used to represent the magnetic flux density, B, of a magnetic system, such as the system of FIG. 2. The magnetic flux lines form continuous, closed loops. Each magnetic flux line represents a linkage (“flux linkage”) between the magnets 120, 130 and the target substrate 140. The flux linkages correspond to the magnetic force between the magnets 120, 130 and the target substrate 140. More flux lines travelling through the target substrate 140 represents a greater force between the target substrate 140 and the magnets 120, 130.

As illustrated by FIG. 2, internal gauge flux lines 150 represent portions of magnetic flux that are inside the magnets 120, 130 and the yoke 110, whereas external gauge flux lines 151 represent portions of magnetic flux that have propagated out of the gauge 100. Additionally, magnetic flux lines may propagate within the target substrate 140, as illustrated by internal target flux lines 152, as well as through the target substrate 140, as illustrated by external target flux lines 153. The presence of external target flux lines 153 indicate that the target substrate 140 is in saturation, and may not accommodate additional flux linkages, as will be further discussed later.

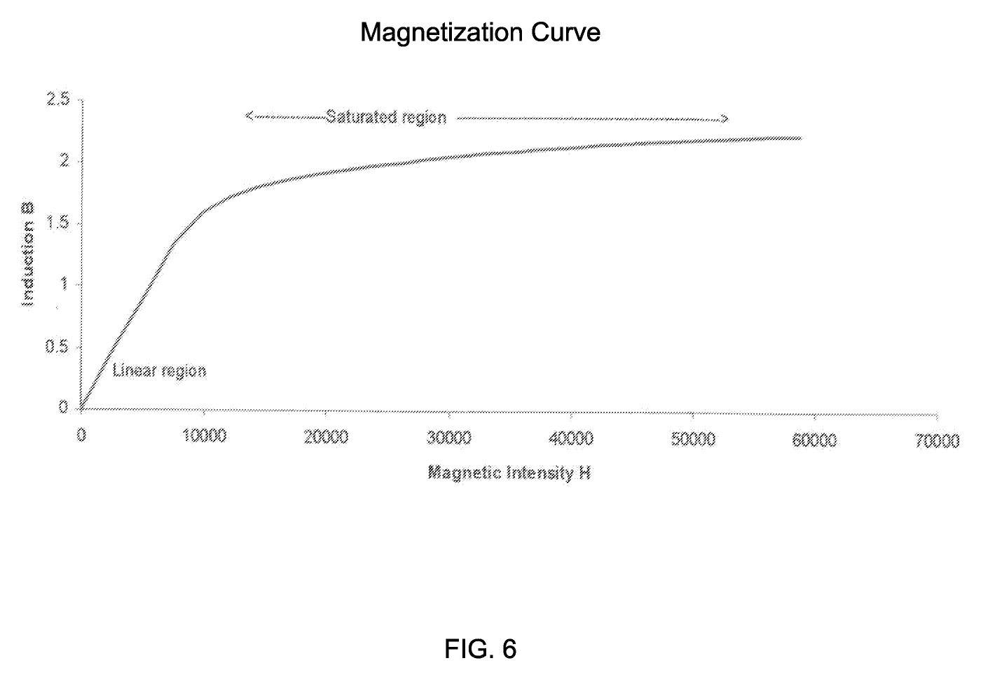

FIG. 6 shows a magnetization curve of steel, with Magnetic Induction or Magnetic Flux Density, B, (induced in target ferromagnetic material) on the Y-axis, and Magnetic Intensity, H, (radiated from a magnetic source) on the X-axis. As shown in FIG. 6, when H is small (less than about 7,000 Amps/Meter), B scales approximately linearly. However, as H gets larger, B begins to increase more slowly, until, at increasingly large H values (greater then about 12,000 Amps/Meter), B grows very slowly by comparison, seeming to approach a value asymptotically. The region of the graph in which B grows slowly compared to the growth of H is called the “saturation region”. When the target substrate 140 (shown in FIG. 1) is in the saturation region or “in saturation,” a greater Magnetic Intensity, H, may increase the total magnetic flux density, B, a very small (substantially negligible) amount. Alternatively, when the target substrate 140 is near the non-saturation portion of the magnetization curve, a variation in the target substrate 140, such as a thick region, may take the target substrate 140 out of saturation, which may result in unexpected force readings, such as a smaller increase in force than would be expected if the material were in saturation.

Further, the force between the magnets 120, 130 and the target substrate 140 may not vary with the thickness of the target substrate 140 if the target substrate 140 is not saturated. A non-saturated target substrate 140 indicates that all of the available magnetic flux radiating from the magnets 120, 130 is propagating through the target substrate 140 and that all possible flux linkages have been formed between the target substrate 140 and the magnets 120, 130 and that none have propagated through and beyond the target substrate 140. Therefore, if a variation in the target substrate 140, such as a thick region, is seen by the magnet, additional linkages will not form, which will result in the same magnitude of force as was seen between the magnets 120, 130 and the target substrate 140 at the thinner region. By contrast, when the target substrate 140 is in saturation, magnetic flux will propagate through the target substrate 140 and will appear on the other side of the target substrate 140, indicating that the magnets 120, 130 are radiating more magnetic flux than the target substrate 140 can conduct. When a thicker region in the target substrate 140 is seen by the magnets 120, 130, some of this extra magnetic flux will be conducted by the additional material, increasing the magnetic force between the target substrate 140 and the magnets 120, 130.

FIG. 3 illustrates the gauge 100 of FIGS. 1 and 2 interacting with a target substrate 141 that is thick, relative to the target substrate 140 (shown in FIGS. 1 and 2). The target substrate 141 comprises the same ferromagnetic material as the target substrate 140, and is held at the same standoff distance, sd, from the magnets 120, 130 to the closest surface of the target substrates 140, 141.

FIG. 3 also shows magnetic flux lines 150, 151, 152, and 153. As illustrated in FIG. 3, due to greater thickness, the target substrate 141 is able to accommodate a greater number of internal target flux lines 152 (flux linkages) than the target substrate 140 of FIGS. 1 and 2. This is also indicated by fewer external target flux line 153 propagating out of the target substrate 141, relative to the target substrate 140. The larger number of flux linkages translates into a greater force between the target substrate 141 and the magnets 120, 130, relative to the force between the target substrate 140 and the magnets 120, 130. Given that all other relevant variables are known or measurable, and that the target substrates 140, 141 are in saturation, the difference in force will correspond to the difference in thickness. Thus, the difference in force may be used to calculate the difference in thickness between the target substrate 140 and the target substrate 141.

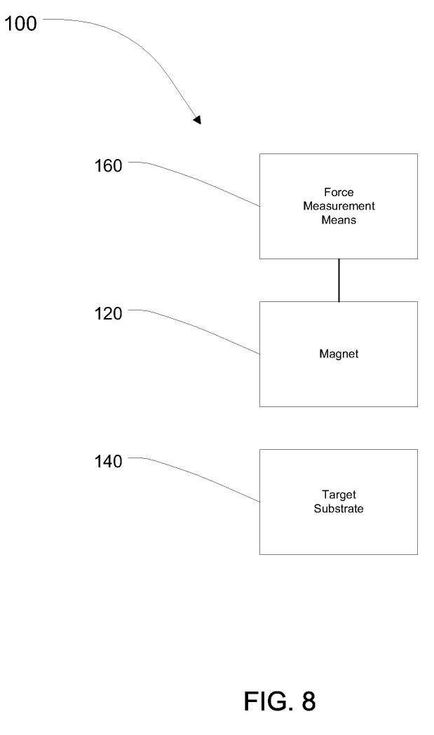

In another embodiment, the gauge 100 may include only a single magnet 120 with a force measurement means 160 that is configured to measure the force between the magnet 120 and a target substrate 140, as shown in FIG. 8.

The gauge 100 may further comprise other suitable components, such as sensors to correct for non-ideal conditions that the gauge 100 may encounter. For example, if the temperature of the gauge 100 and/or the target substrate 140 (shown in FIG. 1) changes, the Magnetic Flux Density, B, in the target substrate 140 may also change. A change in the Magnetic Flux Density, B, may result in a variation of the measured force, which may cause an undesired change in the apparent measured thickness of the target substrate 140. The change can be compensated for by operatively connecting a temperature measurement means 176 to the gauge 100. The temperature reading from the temperature measurement means 176 may be used to correct the measured thickness of the target substrate 140, as would be understood by one of ordinary skill in the art, given the benefit of this disclosure. The temperature measurement means 176 may be placed on or near the gauge 100, or may be placed in a separate location, given that the separate location is maintained at substantially the same temperature as the gauge 100. Alternatively, the temperature may be input into the system, or corrected for, manually.

Another suitable component may be a speed measurement means 174. The speed measurement means 174 may be added to correct for eddy currents created by movement from the gauge 100 and/or the target substrate 140 with respect to each other. Movement in the axial direction will result in eddy currents being created in the target substrate 140. Such eddy currents create opposing magnetic forces, which may change the measured force, and thus the apparent thickness of the target substrate 140. The eddy currents may be compensated for by factoring in the speed of the target substrate 140 with respect to the gauge 100. The speed measurement means 174 may be connected to and/or located on or near the gauge 100. Alternatively, the speed may be measured or calculated through other means and may be input into the system, such as, for example, manually or another suitable input means.

Additionally, a change in the orientation of the gauge 100 with respect to the ground may change the output of the force measurement means 160; the force of gravity may add or subtract from the force seen by the force measurement means 160. The force of gravity can be accounted for by operatively connecting a tilt angle measurement means 178 to the gauge 100, and using measurements from the tilt-angle sensor to adjust the thickness measurement of the target substrate 140. Alternatively, the gauge 100 may be held at a substantially constant angle and/or the tilt angle of the gauge 100 may be manually input into and/or compensated for in the system.

The gauge 100 may be operatively connected to a computer 180 that may interface with the force measurement means 160, the speed measurement means 174, the temperature measurement means 176, and/or the tilt angle measurement means 178,

The gauge 100 may further comprise other suitable components that may correct for non-ideal conditions that may be encountered by the gauge 100, as would be apparent to one of ordinary skill in the art, given the benefit of this disclosure.

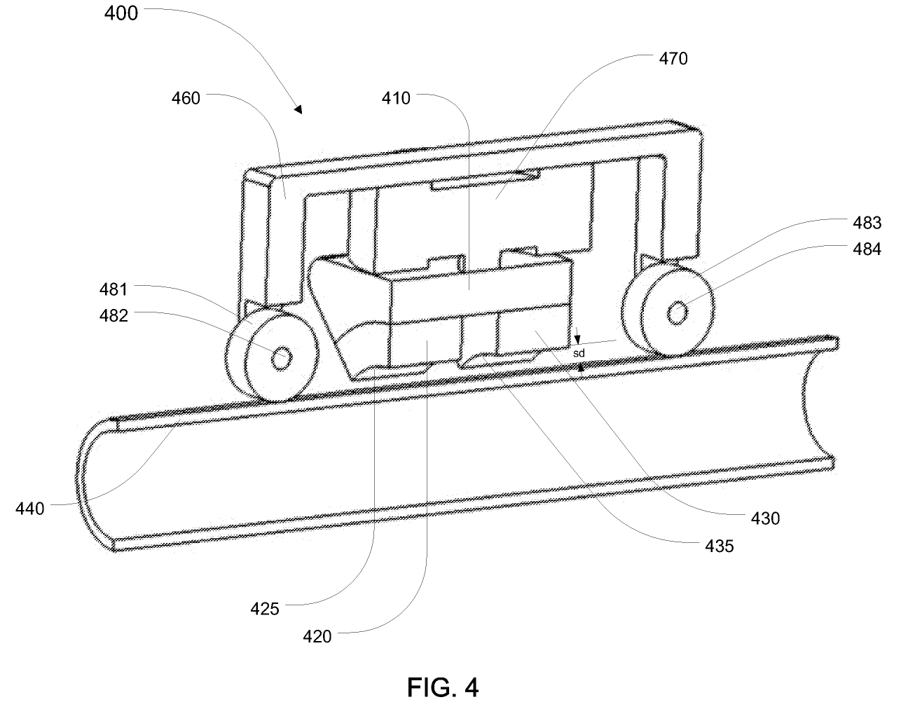

FIG. 4 illustrates another embodiment of a thickness measurement gauge 400 comprising a first magnet 420 having a surface 425 and a second magnet 430 having a surface 435. The magnets 420, 430 are connected by a yoke 410, the yoke 410 comprising ferromagnetic material. A target substrate 440 comprising ferromagnetic material is also shown in FIG. 4. The surfaces 425, 435 have been contoured to complement the target substrate 440. This contouring may ensure that a flaw or variation in the target substrate 440 that is not centered with the magnets 120, 130 may be measured substantially accurately. The target substrate 440 of FIG. 4 may comprise a portion of a pipe, a tube, coiled tubing, a strip, a bar, or other suitable object. Other target substrates 440 would be apparent to one of ordinary skill in the art, given the benefit of this disclosure.

The embodiment of FIG. 4 further comprises a force measurement means 470 connected to the yoke 410 and to a support arch 460. As shown in FIG. 4, the support arch 460 is generally U-shaped and comprises a movement means, such as a sliding member or a first roller 481 connected to the support arch 460 at one end through a first rotatable axle 482, and a second rotatable roller 483 connected to the support arch 460 at the other end through a second axle 484. Movement means may comprise other suitable components, as would be apparent to one of ordinary skill in the art, given the benefit of this disclosure.

The support arch 460 is substantially rigid and may provide a substantially uniform and constant standoff distance, sd, between the magnets 420, 430 and the target substrate 440. The first rotatable roller 481 and the second rotatable roller 483 may roll smoothly along the outer surface of the target substrate 440 enabling the gauge 400 and the target substrate 440 to be moved smoothly in relation to each other while keeping the standoff distance substantially the same.

Though the support arch 460 will ideally keep the magnets 420, 430 at a substantially constant standoff distance, sd, it is recognized that variation in the standoff distance, sd, may be present. To minimize the effects of this potential variation, the standoff distance, sd, may be set at about equal to the greatest expected thickness of the target substrate 440. Greater standoff distances, sd, such as two or three times the greatest expected thickness of the target substrate 440, may further minimize the effect of variation in the standoff distance, sd. Alternatively, a distance measurement means 172 (shown in FIG. 1) may be used to measure the distance between the target substrate 440 and the magnets 420, 430. Measurements from the distance measurement means 172 may be used to correct for variations in the standoff distance. The distance measurement means 172 may interface with the computer 180 (shown in FIG. 1).

The gauge 400 may be used to measure the absolute thickness of the target substrate 440 or may be used to measure relative variations and/or flaws in the thickness of the target substrate 440. For example, given that the relevant variables of the system illustrated by FIG. 4, such as the characteristics of the target substrate 440 and the characteristics of the gauge 400 are known, the target substrate 440 may be placed at the standoff distance, sd, a force measurement may be taken, and the thickness of the target substrate 440 may be calculated.

In another example, the gauge may be used to calculate the relative thickness of the target substrate 440. A sample force measurement may be taken at a reference point on the target substrate 440, such as at one end of the target substrate 440 or at another suitable point that may be measured independently to verify that the force measurement is representative of the thickness of the target substrate 440. The sample force measurement may be compared against other measurements to show variation in the target substrate 440. Alternatively, the gauge 400 may be used to take dynamic measurements along the target substrate 440, outputting the measurements to be analyzed in substantially real time or as a whole or in parts, at a later time.

The force measurement means 470 may be any device that can measure force. For example, the force measurement means 470 may be a mechanical scale, an accelerometer, a transducer, a load cell, a fiber optic strain sensor, hydrostatic load cell, spring balance gauge, or other suitable means. Some sensors that may potentially be used with the gauge 400 are among the Honeywell, Sensotec line of load cells, such as, for example, the Model 41 Precision Low Profile Load Cell. The force measurement means 470 may have an interface that may be used in a larger system, such as with a system that comprises one or more cables, connectors, in-line amplifiers, display units, power supplies, chart recorders, alarm panels, or data acquisition computers, as would be apparent to one of ordinary skill in the art given the benefit of this disclosure. For example, the force measurement means 470 may be operatively connected to a device, such as a computer 180 (shown in FIG. 1), that may monitor, record, and/or compare the measurements taken by the force measurement means 470 and may output a signal or alarm, based at least partially on the measurements outputted by the force measurement means. The signal or alarm may indicate that a flaw or a violation of a specified variance in the target substrate has been detected. Further, the computer may output a comparison of two measurements, and absolute measurement, a running output of a measurement, or another suitable measurement, as would be apparent to one of ordinary skill in the art, given the benefit of this disclosure. The output of the computer 180 and/or the force measurement means 470 may be displayed on a display (not shown) that is operatively connected to the computer 180 and/or the force measurement means 470.

The gauge 400 may be used in an environment where flammable gases may be encountered, such as on or around oil refineries, oil wells and/or gas wells. In such environments, it may be desirable for electrical equipment to be constructed such that an electrical fault is incapable of igniting flammable gases. Equipment constructed toward overcoming accidental gas ignition is generally required to be certified by an approving authority, such as Underwriters Laboratories, OSHA, FM Global, Nationally Recognised Testing Laboratories, ETL, NSF International, the Canadian Standards Association, The TÜV Rheinland Group, and those approving authorities cooperating with the ATEX directive. Currently, some types of electrical sensing instruments such as pressure, temperature, and force measurement means are available for purchase with certification from the approving authority for use in such environments. A gauge 400 comprising a force measurement means 470 that is certified by the approving authority may be suitable for use in an environment where flammable gases may be encountered.

The gauge 400 may further comprise other suitable components, such as sensors to correct for non-ideal conditions that the gauge 400 may encounter, as described previously.

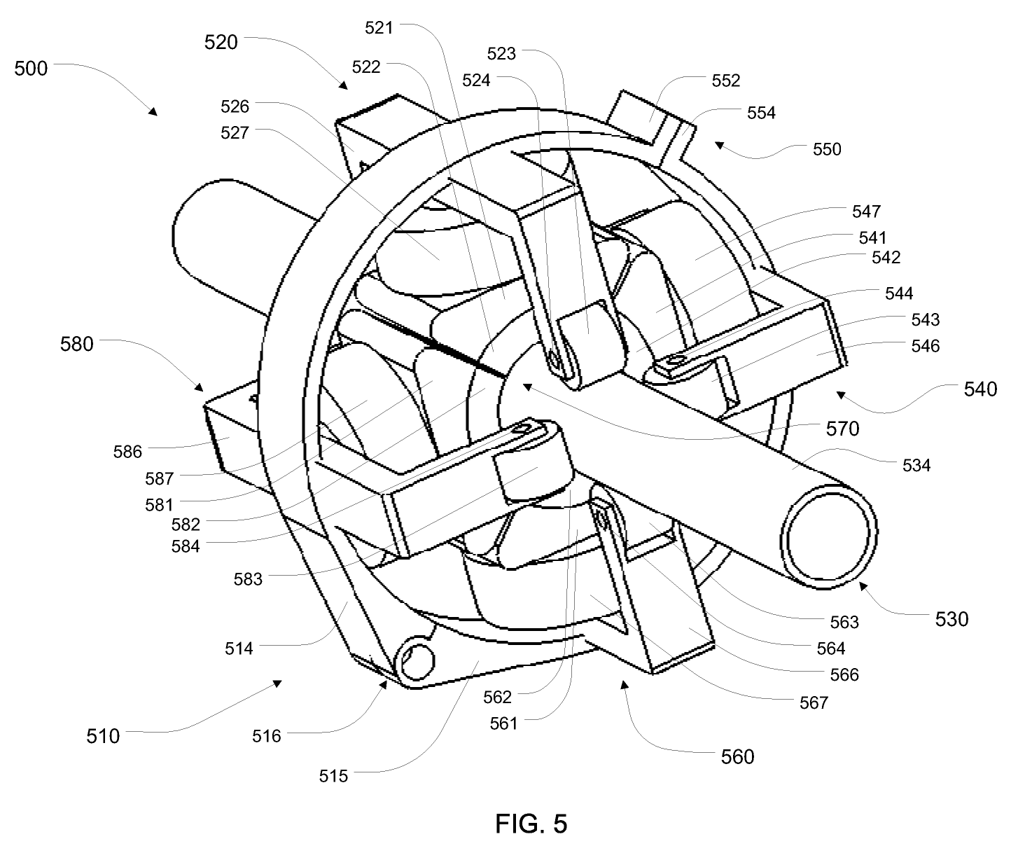

FIG. 5 is a perspective view of yet another embodiment of a thickness measurement gauge 500. The gauge 500 comprises a gauge frame 510, a first, second, third, and fourth gauge section 520, 540, 560, and 580 respectively. Each of the gauge sections 520, 540, 560, and 580 comprise a support arch 526, 546, 566, and 586, a force measurement means 527, 547, 567, and 587, a yoke 521, 541, 561, and 581, a first magnet 522, 542, 562, and 582, and a second magnet (not shown). The support arches 526, 546, 566, and 586 further comprise rollers 523, 543, 563, and 583 and axles 524, 544, 564, and 584, and may act as a movement means, and may keep the magnets at a substantially constant standoff distance from a target substrate 530. Other movement means and standoff means would be apparent to one of ordinary skill in the art, given the benefit of this disclosure.

The gauge frame 510 further comprises a first frame member 514 and a second frame member 515, pivotally connected at one end by a hinge 516 and connected at the other end by a connecting means 550. The connecting means 550 illustrated in FIG. 5 comprises a first tab 552, a second tab 554, and a securing means (not shown). The first frame member 514 and the second frame member 515 of the gauge frame 510 may be connected with other suitable components, as would be apparent to one of ordinary skill in the art, given the benefit of this disclosure.

FIG. 5 further illustrates the target substrate 530. The target substrate 530 may comprise a portion of a pipe, a tube, coiled tubing, a strip, a bar, or other suitable substrate. The target substrate 530 is positioned within an aperture 570 formed at the convergence of the four gauge sections 520, 540, 560, and 580. The magnets may be contoured to substantially match the outer surface 534 of the target substrate 530. To position the target substrate 530 within the gauge 500 illustrated in FIG. 5, the connecting means 550 may be disengaged, allowing the gauge frame 510 to open at the hinge 516, separating the first and second frame members 514, 515 and allowing the target substrate 530 to be place into or taken out of the aperture 570. Alternatively, the connecting means 550 may be disengaged, allowing the gauge 500 to be opened at the hinge 516 and removed from around the target substrate 530. Additionally, the target substrate 530 may be fed through the aperture 570 from one end of the target substrate 530, which may reduce or eliminate the need for the first frame member 514 and the second frame member 515 to be disconnected from each other.

In the embodiment illustrated in FIG. 5, the magnets are contoured to substantially match the contour of the target substrate 530, which may maintain the standoff distance, sd, at substantially the same distance from the outer surface of the target substrate 530 across the outer surface of the magnets. The gauge 500 may be configured such that the magnets may be replaceable, for example, with differently shaped or contoured magnets which may allow the contours a of differently shaped the target substrate 530 to be substantially matched.

As previously described, the gauge 500 may measure the thickness of the target substrate 530. As configured in FIG. 5, the gauge 500 may take four measurements simultaneously, in the areas of the four gauge sections 520, 540, 560, and 580. The four measurements may substantially measure the absolute or relative thickness of a full cross-section of the target substrate 530.

The gauge 500 may be configured such that it may be moved relative to the target substrate 530, or such that the target substrate 530 is moved relative the gauge 500. By moving the gauge 500 and/or the target substrate 530 relative to each other, the relative or absolute thickness of the target substrate 530 may be measured. As configured, the gauge 500 may measure substantially all the variations and/or flaws in the target substrate 530 with a single pass along the length of the target substrate 530.

The gauge 500 may be used advantageously in an environment where a large amount of pipe or coiled tubing, comprising ferromagnetic material, is being installed. For long term reliability, it may be desirable to measure the thickness of the pipe or coiled tubing, monitoring changes in thickness for flaws and/or manufacturing variation. The pipe or tubing may be moved through the aperture 570 of the gauge 500. The gauge 500 may continually measure the absolute and/or relative thickness of the pipe or coiled tubing as it moves through the aperture, outputting measurements that may be compared and/or interpreted by a person and/or computer.

The gauge 500 may be used in an environment where flammable gases may be encountered, such as on or around oil refineries, oil wells and/or gas wells. A gauge 500 comprising force measurement means 527, 547, 567, and 587 that are certified by an approving authority, such as Underwriters Laboratories, OSHA, FM Global, Nationally Recognised Testing Laboratories, ETL, NSF International, the Canadian Standards Association, the TÜV Rheinland Group, and those approving authorities cooperating with the ATEX directive, may be suitable for use in an environment where flammable gases may be encountered, as described previously.

The gauge 500 may further comprise other suitable components, such as sensors to correct for non-ideal conditions that the gauge 500 may encounter, as described previously.

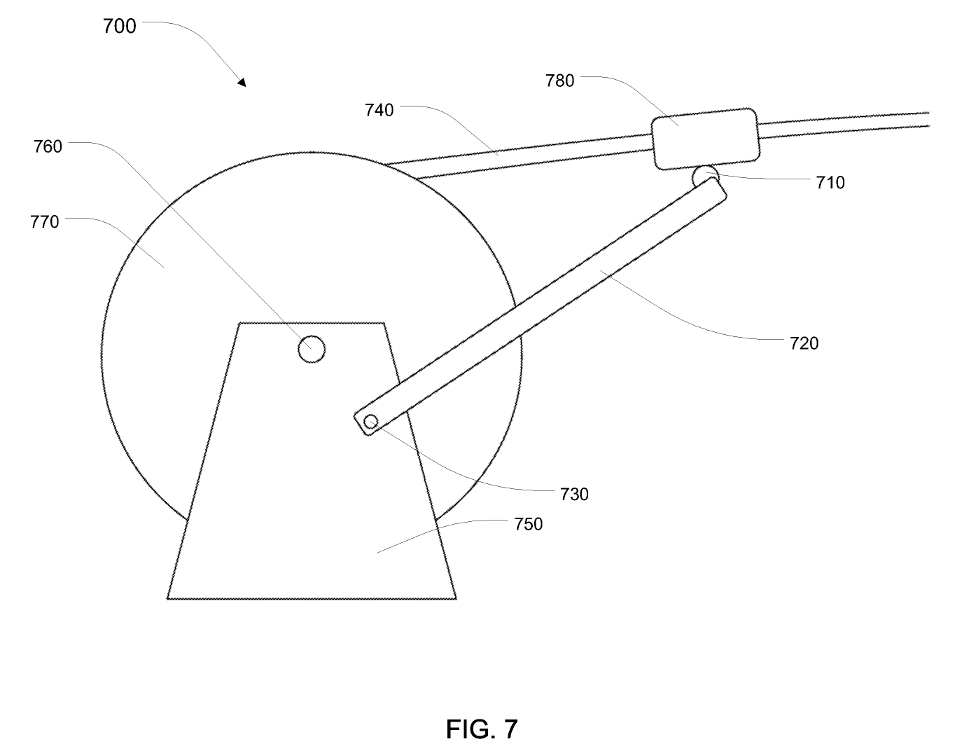

FIG. 7 illustrates a coiled tubing reel 700 that may be used in an environment where a large amount of coiled tubing, comprising ferromagnetic material, may be installed, such as, for example, on or around oil wells and/or gas wells. The coiled tubing reel 700 includes an embodiment of a thickness measurement gauge 780, such as, for example, a previously described embodiment of a thickness measurement gauge 100, 400, 500. The coiled tubing reel 700 illustrated in FIG. 7 comprises ferromagnetic tubing 740 that may be wound around a reel 770, which is rotatably connected to a frame 750 with a connecting means, such as a reel axle 760. The gauge 780 is connected to the frame 750 though one or more connecting means, such as an articulated connector 710 and a support member 720, which may be rotatably connected to the frame 750 by a connecting means, such as an axle 730. The tubing 740 may pass to a side of the gauge 780 or through an aperture formed in the gauge 780, as it is withdrawn from or rewound upon the reel 770. As illustrated in FIG. 7, the gauge 780 is configured to measure the wall thickness of the tubing 740 by measuring the force between a magnet and the tubing. The coiled tubing reel 700 may be used in an environment where flammable gases may be encountered, such as on or around oil refineries, oil wells and/or gas wells.

While this invention has been described in conjunction with the exemplary embodiments outlined above, it is evident that many alternatives, modifications, and variations will be apparent to those skilled in the art.

For example, equivalent elements may be substituted for those specifically shown and described, certain features may be used independently of other features, and the number and configuration of various vehicle components described above may be altered, all without departing from the spirit or scope of the invention as defined in the appended claims.

Such adaptations and modifications should and are intended to be comprehended within the meaning and range of equivalents of the disclosed exemplary embodiments. It is to be understood that the phraseology of terminology employed herein is for the purpose of description and not of limitation. Accordingly, the foregoing description of the exemplary embodiments of the invention, as set forth above, are intended to be illustrative, not limiting. Various changes, modifications, and/or adaptations may be made without departing from the spirit and scope of this invention.

What is claimed is:

1. A gauge for measuring the thickness of a ferromagnetic substrate, the gauge comprising;
at least one first magnet with a first polarity, the first magnet having a first polarity;
a force measurement means operatively connected to the at least one first magnet;
wherein the force measurement means is configured to measure the force between the at least one first magnet and a substrate, the substrate comprising ferromagnetic material; and
wherein the at least one magnet is configured to magnetically saturate the substrate.

2. The gauge of claim 1, further comprising:
at least one second magnet, having a second polarity, the at least one second magnet being oriented such that the second polarity is opposite the first polarity;
a yoke, comprising ferromagnetic material, connected to the at least one first magnet and the at least one second magnet;
wherein the at least one first magnet is in substantially a same plane as the at least one second magnet, and
wherein the force measurement means is operatively connected to the at least one first magnet and the at least one second magnet.

3. The gauge of claim 1, further comprising:
a standoff means connected to the force measurement means and configured to hold the at least one first magnet at a standoff distance from the substrate.

4. The gauge of claim 1, further comprising:
a distance measurement means, wherein the distance measurement means is configured to measure the distance between the at least one first magnet and the substrate.

5. The gauge of claim 1, wherein the substrate comprises a pipe, a tube, coiled tubing, a strip, a shim, or a plate.

6. The gauge of claim 1, wherein the first magnet and the second magnet are contoured to substantially match a contour of the substrate.

7. The gauge of claim 3, wherein the standoff distance is configured to be about equal to or greater than the greatest expected thickness of the substrate.

8. The gauge of claim 1, wherein the force measurement means comprises a mechanical scale, an accelerometer, a transducer, a load cell, a fiber optic strain sensor, a hydrostatic load cell, or a spring balance gauge.

9. The gauge of claim 1, wherein the force measurement means is configured to prevent accidental ignition of flammable matter.

10. The gauge of claim 1, wherein the force measurement means is certified by an approving authority for use in environments comprising flammable matter.

11. The gauge of claim 1, wherein the standoff means comprises an arch and a movement means.

12. The gauge of claim 11, wherein the movement means comprises a sliding member or a rotatable roller.

13. The gauge of claim 1, further comprising a frame, the frame comprising a first frame member and a second frame member, the first frame member and the second frame member being pivotally connected together, wherein a portion of the frame is connected to the standoff means.

14. An apparatus for inspecting the thickness of a substrate, the apparatus comprising:
a frame, having a first frame member and a second frame member, the first frame member and the second frame member being pivotally connected together;
at least one thickness measurement gauge, the at least one thickness measurement gauge comprising a first magnet with a first polarity, a second magnet having a second polarity, the second magnet being oriented such that the second polarity is opposite the first polarity, a yoke connecting the at least one first magnet and the at least one second magnet, a force measurement means connected to the yoke, and a standoff means operatively connected to the force measurement means; and
an aperture formed in the middle of the frame, the aperture being configured to accommodate a substrate that comprises ferromagnetic material,
wherein the force measurement means of the at least one thickness measurement gauge is configured to measure the force between the substrate and the at least one first magnet and the at least one second magnet.

15. The apparatus of claim 14, wherein the force measurement means is configured to connect to a computer.

16. The apparatus of claim 14, further comprising a speed sensor, the speed sensor being configured to measure a speed, the speed being that of the substrate relative to the apparatus.

17. The apparatus of claim 14, further comprising a temperature sensor, wherein the temperature sensor is configured to measure a temperature substantially proximate to the apparatus.

18. The apparatus of claim 14, further comprising a tilt angle sensor, wherein the tilt angle sensor is configured to measure a tilt of the apparatus with respect to the Earth.

19. A method for measuring the thickness of a substrate comprising:
holding at least one magnet at a standoff distance from a substrate, the substrate comprising ferromagnetic material;
moving the substrate with respect to the magnet;
measuring the force between the substrate and the magnet using a force measurement means;
outputting the measured force between the substrate and the magnet from the force measurement means; and
comparing the measured force at a first point along the substrate to the measured force at a second point along the substrate to find variation in the substrate.

20. The method of claim 19, further comprising using the measurement of the force between the substrate and the magnet to calculate a thickness of the substrate.

21. The method of claim 19, further comprising calculating a difference in thickness between the first point and the second point.

22. The method of claim 19, wherein the substrate comprises a pipe, tube, coiled tubing, strip, or plate.

23. The method of claim 19, wherein the force measurement means comprises a mechanical scale, an accelerometer, a transducer, a load cell, a fiber optic strain sensor, a hydrostatic load cell, or a spring balance gauge.

24. The method of claim 19, wherein the force measurement means is certified by an approving authority to be used in a flammable environment.

25. The method of claim 19, further comprising displaying an output based at least partially on the outputted measured force.
